(19) United States
(12) Patent Application Publication
(10) Pub. No.: US 2015/0105034 A1
(43) Pub. Date: Apr. 16, 2015

(54) WIRELESS TRANSMISSION DEVICE

(71) Applicant: Euclid Technology Co., Ltd, Zhongli City (TW)

(72) Inventors: Ching-Sheng TWU, Zhongli City (TW); Fu-Kai CHUANG, New Taipei City (TW); Fang-Yu TU, Pingzhen City (TW); Hsiao-Ying PENG, Zhongli City (TW)

(73) Assignee: Euclid Technology Co., Ltd, Zhongli City (TW)

(21) Appl. No.: 14/139,251

(22) Filed: Dec. 23, 2013

(30) Foreign Application Priority Data
Oct. 11, 2013 (TW) 102136867

(51) Int. Cl. H04B 1/40; H04B 1/04

(52) U.S. Cl. CPC H04B 1/401; H04B 1/04
USPC 455/90.2; 455/92

(57) ABSTRACT

A wireless transmission device includes an audio fetching module, a storage module, a processing module and a wireless transmission module. The processing module electrically connects to the audio fetching module and the storage module, and the wireless transmission module electrically connects to the processing module. The audio fetching module acquires an audio signal. The processing module either stores the audio signal in the storage module or reads out the stored audio signal when being enabled. The wireless transmission module enables the processing module and transmits the stored audio signal according to the transmission enabling signal.

### CROSS-REFERENCE TO RELATED APPLICATIONS

This non-provisional application claims priority under 35 U.S.C. §119(a) on Patent Application No(s). 102136867 filed in Taiwan, R.O.C. on Oct. 11, 2013, the entire contents of which are hereby incorporated by reference.

### TECHNICAL FIELD

The disclosure relates to a wireless transmission device and more particularly to a wireless transmission device with high power efficiency.

### BACKGROUND

Generally, most household measuring devices for health measurement, such as a household glucosemeter, measure only one kind of data and store it in a storage media, and the stored data needs to be transferred to an analysis device manually. However, users may forget to turn off such a measuring device after the data transmission has been completed, and it will waste power to keep the measuring device turned on.

### SUMMARY

According to an embodiment, a wireless transmission device includes an audio fetching module, a storage module, a processing module and a wireless transmission module. The processing module electrically connects to the audio fetching module and the storage module, and the wireless transmission module electrically connects to the processing module. The audio fetching module acquires an audio signal. The processing module either stores the audio signal in the storage module or reads out the stored audio signal. The wireless transmission module enables the processing module and transmits the stored audio signal according to a transmission enabling signal.

### BRIEF DESCRIPTION OF THE DRAWINGS

The present invention will become more fully understood from the detailed description given herein below along with the accompanying drawings which are for illustration only, thus are not limitative of the present invention, and wherein:

FIG. 1 is a block diagram of a wireless transmission device according to an embodiment of the disclosure;

FIG. 2 is a block diagram of the wireless transmission module in FIG. 1 according to an embodiment of the disclosure; and

FIG. 3 is a flowchart showing the operation of the wireless transmission device according to an embodiment of the disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

The disclosure provides a wireless transmission device which can automatically operate under a working mode after receiving a command from a handheld, and can automatically operate under a hibernation mode instead of the working mode after accomplishing the received command, whereby the unnecessary power consumption can be reduced or saved.

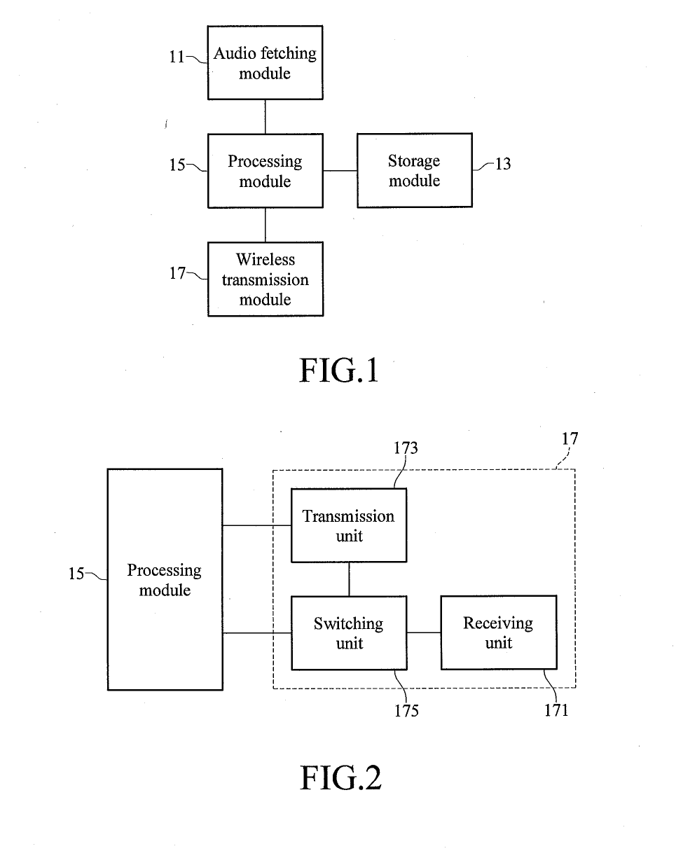

FIG. 1 is a block diagram of a wireless transmission device according to an embodiment of the disclosure. The wireless transmission device includes an audio fetching module 11, a storage module 13, a processing module 15 and a wireless transmission module 17. The processing module 15 electrically connects to the audio fetching module 11, the storage module 13 and the wireless transmission module 17.

The audio fetching module 11 can acquire audio signals. In particular embodiments, the audio fetching module 11 includes one or more sound collectors and one or more analog-to-digital converters (ADCs). The sound collector can collect audio energy and convert the collected audio energy into analog electric signals, and the ADC can convert analog electric signals into digital signals, i.e. audio signals. In particular embodiments, one or more filters can further be disposed between the one or more collectors and the one or more ADCs. As an example and not by way of limitation, the filter can be a low-pass filter or band-pass filter, and can be an active filter (including an amplification circuit) or a passive filter (for example, composed of passive electric components such as capacitors, resistors and inductors). As an example and not by way of limitation, the pass-band frequency of the filter is between 20 and 2000 Hz or between 20 and 20000 Hz.

The storage module 13 is configured to store data and more particularly to store the audio signal acquired by the audio fetching module 11. In particular embodiments, the storage module 13 includes one or more erasable read only memories (EROMs) through which the wireless transmission device can be minimized and repeatedly write and read out data.

The processing module 15 can store the audio signals, acquired by the audio fetching module 11, in the storage module 13 or read out the stored audio signals in the storage module 13 when being enabled. In this and some embodiments, the processing module 15 writes a set of audio signals as one or more audio files into the storage module 13 and adds an end-of-file (EOF) flag in each audio file. When reading out one audio file in the storage module 13, the processing module 15 can determine that one audio file ends by reading the EOF, whereby the processing module 15 can disable the modules (including itself) in the wireless transmission device except the wireless transmission module 17. In particular embodiments and not by way of limitation, the processing module 15 can be an application-specific integrated circuit (ASIC), an advanced RISC machine (ARM), a central processing unit (CPU), a single-chip controller or other suitable computing and commanding components.

The wireless transmission module 17 can enable the processing module 15 and transmit the audio signal stored in the storage module 13 according to a transmission enabling signal. In particular embodiments, when the wireless transmission device operates under the hibernation mode, only the wireless transmission module 17 is enabled and the other modules are disabled. Herein, when the wireless transmission module 17 receives a transmission enabling signal, the processing module 15 is enabled by the wireless transmission module 17 to control the other modules in the wireless transmission device. Meanwhile, the processing module 15 can read out the audio signal stored in the storage module 13 and control the wireless transmission module 17 to wirelessly transmit the audio signal to a destination device sending the transmission enabling signal. When the destination device sending the transmission enabling signal sends a transmission disabling signal to the wireless transmission module 17, the processing module 15 disables the other modules except the wireless transmission module 17 and then is disabled by the wireless transmission module 17.

In an embodiment, the wireless transmission module 17 in FIG. 2 includes a receiving unit 171, a transmission unit 173 and a switch unit 175. The transmission unit 173 and the switch unit 175 electrically connect to the processing module 15, and the switch unit 175 electrically connects to the receiving unit 171 and the transmission unit 173.

The receiving unit 171 can detect the transmission enabling signal to output a sensing signal. As an example and not by way of limitation, the receiving unit 171 can include one or more induction coils and one or more rectifiers, and the rectifier can be embodied by passive components. Therefore, the receiving unit 171 may not consume the power supplied to the wireless transmission device.

The transmission unit 173 can wirelessly transmit audio signals (i.e. signals of audio files) outputted by the processing module 15 when being enabled. In an embodiment, the transmission unit 173 combines the audio signal with a carrier wave and then wirelessly transmits the carrier wave with the audio signal to the destination device sending the transmission enabling signal. As an example and not by way of limitation, the method for combining the audio signal with the carrier wave may be frequency modulation (FM), amplitude modulation (AM), phase modulation (PM), frequency-shift keying, amplitude-shift keying, phase-shift keying or other suitable modulations.

The switch unit 175 can control the processing module 15 and/or the transmission unit 173 according to the sensing signal. When the transmission enabling signal is a wireless search signal, it designates that the destination device just attempts to search for the wireless transmission device. Herein, the receiving unit 171 gets a search sensing signal from the destination device, and the switch unit 175 enables the transmission unit 173 to send a signal to the destination device according to the search sensing signal. When the transmission enabling signal is a transmission request signal, it designates that the destination device attempts to command the wireless transmission device to send one or more sets of stored audio signals (i.e. one or more audio files). Herein, the receiving unit 171 gets a transmission request sensing signal from the destination device, and the switch unit 175 enables the processing module 15 to read out one or more audio files from the storage module 13 and then send them to the destination device according to the transmission request sensing signal. When the transmission enabling signal is an interruption request signal, it designates that the destination device attempts to command the wireless transmission device to stop sending signals. Herein, the receiving unit 171 gets an interruption request sensing signal from the destination device, and the switch unit 175 disables the processing module 15 and the transmission unit 173 according to the interruption request sensing signal.

Moreover, when both of the receiving unit 171 and the transmission unit 173 have been idle (i.e. no signal is transmitted between the wireless transmission device and any destination device) for a preset period (e.g. 15 or 30 seconds), it designates that the wireless transmission device has accomplished the present signal transmission task and not received commands from any destination device yet. Herein, the switch unit 175 will disable the processing module 15 and the transmission unit 173. As an example and not by way of limitation, the wireless transmission module 17 can be a Bluetooth receiver, a wireless receiver in IEEE 802.11 standard, or other suitable wireless receivers.

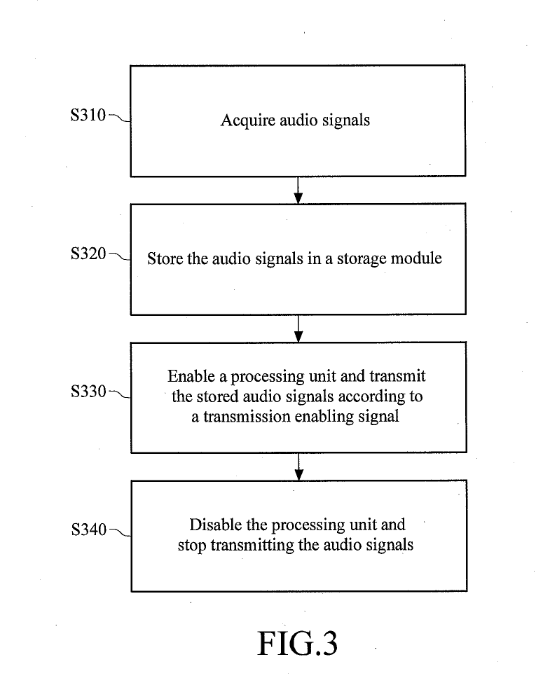

The operation of the wireless transmission device in the disclosure is described as follows. Refer to FIG. 1 and FIG. 3, the wireless transmission device performs the following steps. First, the audio fetching module 11 acquires audio signals (step S310), and the processing module 15 stores the acquired audio signals in the storage module 13 (step S320). Then, the wireless transmission module 17 enables the processing module 15 and transmits the stored audio signals according to a transmission enabling signal (step S330). Finally, the processing module 15 is disabled and the transmission of the audio signals is stopped (step S340).

In the aforementioned embodiments, the wireless transmission device, according to signals from the destination device, determines which module should be enabled or disabled, whereby the power consumption may be reduced substantially.

As an example and not by way of limitation, the wireless transmission device can be applicative to a wireless electronic stethoscope. The wireless electronic stethoscope is set to operate under the hibernation mode after recording heartbeat or breathiness into its memories. Herein, another electric device such as a mobile phone or computer can wirelessly search out the wireless electronic stethoscope. When receiving radio waves from the electric device for searching available wireless electronic stethoscopes, the wireless electronic stethoscope will reply the radio waves to establish a wireless connection between the wireless electronic stethoscope and the electric device. Subsequently, a processing module in the wireless electronic stethoscope is enabled to read and send one more heartbeat or breathiness files which are stored in the wireless electronic stethoscope after receiving a command, specifying this operation, from the electric device. Moreover, the electric device can also send a command for interrupting the file transmission at any time.

On the other hand, when the one or more files are transmitted completely or when the connection between the electric device and the wireless electronic stethoscope is off (i.e. no signal transmission between the electric device and the wireless electronic stethoscope), the wireless electronic stethoscope will disable all modules and automatically operate under the hibernation mode instead of the working mode until any electric device searches for or commands it.

What is claimed is:

1. A wireless transmission device, comprising:
an audio fetching module, configured to acquire an audio signal;
a storage module;
a processing module, electrically connecting to the audio fetching module and the storage module, and being configured to either store the audio signal in the storage module or read out the audio signal from the storage module when being enabled; and
a wireless transmission module, electrically connecting to the processing module and being configured to enable the processing module and transmit the audio signal according to a transmission enabling signal.

2. The wireless transmission device according to claim 1, wherein the wireless transmission module further disables the processing module according to a transmission disabling signal.

3. The wireless transmission device according to claim 1, wherein the wireless transmission module comprises:
a receiving unit, configured to detect the transmission enabling signal to output a sensing signal;
a transmission unit, electrically connecting to the processing module and being configured to wirelessly transmit the audio signal when being enabled; and
a switch unit, electrically connecting to the receiving unit, the transmission unit and the processing module and being configured to, according to the sensing signal, control the processing module or the transmission unit.

4. The wireless transmission device according to claim 3, wherein when the transmission enabling signal is a wireless search signal, the sensing signal is a search sensing signal according to which the switch unit enables the transmission unit.

5. The wireless transmission device according to claim 3, wherein when the transmission enabling signal is a transmission request signal, the sensing signal is a transmission request sensing signal according to which the switch unit enables and controls the processing module.

6. The wireless transmission device according to claim 3, wherein when the transmission enabling signal is an interruption request signal, the sensing signal is an interruption request sensing signal according to which the switch unit disables the processing module and the transmission unit.

7. The wireless transmission device according to claim 3, wherein when the transmission unit and the receiving unit have been idle for a preset period, the switch unit disables the processing module and the transmission unit.

8. The wireless transmission device according to claim 1, wherein data of the audio signal has a end-of-file flag, and the processing module disables the processing module according to the end-of-file flag.
